(19) United States
(12) Patent Application Publication
(10) Pub. No.: US 2026/0015189 A1
(43) Pub. Date: Jan. 15, 2026

(54) STACKER RECLAIMER SYSTEM WITH ROTATING ELEVATING CONVEYOR

(71) Applicant: Richmond Engineering Works L.L.C., Pittsburgh, PA (US)

(72) Inventors: Eric C. Koontz, Pittsburgh, PA (US); Kenneth J. Hunt, Pittsburgh, PA (US)

(21) Appl. No.: 19/267,033

(22) Filed: Jul. 11, 2025

Related U.S. Application Data
(60) Provisional application No. 63/670,512, filed on Jul. 12, 2024.

(51) Int. Cl. B65G 65/28; B65G 65/20

(52) U.S. Cl. CPC B65G 65/28; B65G 65/20

(57) ABSTRACT

A stacker reclaimer assembly includes an elevating conveyor extending across a trailing platform. A rotational bearing assembly connects the trailing platform to the elevating conveyor and the rotational bearing provides an opposite end of the elevating conveyor with a rotational range of motion relative to the trailing platform. A curved rail is mounted in an elevated position on the trailing platform between the rotational bearing and the opposite end of the elevating conveyor. A lift assembly extends above the curved rail on the trailing platform and positioning the opposite end of the elevating conveyor at a height relative to the first end of the elevating conveyor. A travel wheel assembly supporting the lift assembly on the curved rail allows for arcuate motion across the curved rail. A drive mechanism provides motion to the lift assembly across the curved rail.

### CROSS REFERENCE TO RELATED APPLICATIONS

This application claims priority to and incorporates by reference U.S. Provisional Patent Application Ser. No. 63/670,512 filed on Jul. 12, 2024, and entitled Stacker Reclaimer System with Rotating Elevating Conveyor.

### BACKGROUND

A stacker reclaimer assembly 100 (i.e., a “stacker reclaimer 100”) is shown in FIG. 1 as a machine, or several machines connected together, and used to stockpile bulk material in a storage yard and later reclaim the material from the stored piles. In some examples, the bulk materials may include metallurgical coal stored in the stackable areas of a storage yard, but the stacker reclaimer assembly 100 is used in numerous scenarios for many different kinds of materials.

The stacker reclaimer 100 travels the storage yard with travel wheels on two rails (similar to railroad tracks but separated by 30 to 40 feet). The rails straddle one or more yard conveyors 138 that can deliver material to the stacker reclaimer 100 or convey reclaimed material from the stacker reclaimer 100. In non-limiting embodiments, the stacker reclaimer 100 may include three main sections: a rotate structure 115 (including the boom 110), a gantry 130 connected to the rotating structure 115 by a slew bearing 125 allowing rotation, and a trailing structure 135 usually connected to the gantry 130. The trailing structure 135 may include a tripper section 150 that allows material from the yard conveyor 138 to feed onto the elevating conveyor 140.

A need for improvement exists in the art of constructing and using stacker reclaimers 100 because the rotate structure 115 that sweeps a boom 110 across a storage yard cannot swing far enough back toward the trailing structure 135 to reach stockpiles in areas close to the rails.

Components of the stacker reclaimer apparatus 100 limit the boom's range of motion when these components block the angle of rotation of the rotating structure 115 controlling the boom 110 and its equipment, such as a bucket wheel 105.

Prior embodiments of stacker reclaimers 100 address the hard-to-access sections of the stockyard by moving stockpile with bulldozers to accessible areas that the boom 110 can reach with the elevating conveyor 140 in its usual position, which is a good bit of excess work for employees. The dozer has to move material back to the stacker reclaimer 100 for reclaiming. This often results in a pile that looks more like the one shown in FIGS. 3A and 3B where much of the material cannot be reached by the reclaimer requiring even more work by the dozer to push material. Prior embodiments also offer two typical solutions to allow the machine to reclaim more material. The first method shown in FIG. 2A requires the trailing structure 135 to be mechanically and electrically disconnected from the gantry 130, leaving a gap 133 between the two, which permits the boom 110 to rotate to about 165°. The second method employs a mechanical extension system 143 that pushes the trailing structure 135 away from the gantry 130 as shown in FIG. 2B. It remains electrically connected to the gantry through festoon cables. The extension system keeps it mechanically connected. Both of these methods result in the loss of more than 100 feet of reclaimable pile on each side of the yard rails.

To make use of this yard area, the stacker reclaimer is moved to the reverse travel limit and the pile is stacked with the boom slew angle at 90°-110° as shown in FIG. 3A. Additional slewing range beyond 110° would more range for reclaiming the material. However, the reclaimable area is limited due to the separation of the trailing structure from the gantry.

### BRIEF SUMMARY OF THE DISCLOSURE

A stacker reclaimer assembly includes an elevating conveyor extending across a trailing platform. A rotational bearing assembly connects the trailing platform to the elevating conveyor and the rotational bearing provides an opposite end of the elevating conveyor with a rotational range of motion relative to the trailing platform. An elevated curved rail is mounted to the trailing platform between the rotational bearing and the opposite end of the elevating conveyor. A lift assembly extends above the curved rail on the trailing platform and positioning the opposite end of the elevating conveyor at a height relative to the first end of the elevating conveyor. A travel wheel assembly supporting the lift assembly on the curved rail allows for arcuate motion across the curved rail. In other embodiments, a curved rail is mounted to the trailing platform on an elevated structure between the rotational bearing and the opposite end of the elevating conveyor. A lift assembly extends above the curved rail on the trailing platform and positions the opposite end of the elevating conveyor at a height relative to the first end of the elevating conveyor. A drive mechanism may be configured to impart motion to the lift assembly and the elevating conveyor along the curved rail via the travel wheel assembly.

In some embodiments, a wire rope winch assembly is mounted to the trailing platform. Two ropes connected to the winch drum extend upwards to vertical sheaves mounted at the elevation of the curved rail. The ropes then extend to horizontal sheaves at opposite ends of the curved rail and back to the lift assembly. As the winch is operated, the wire ropes impart corresponding motion to the lift assembly and the elevating conveyor along the curved rail via the travel wheel assembly. A brake on the winch will be used to stop the motion and hold the elevating conveyor in position while a locking pin is engaged via an electric actuator. The locking pin holds the elevating conveyor in three operating positions, reclaiming left, reclaiming right and stacking. In other embodiments, the drive mechanism may include a chain and sprocket assembly imparting motion to the lift assembly via a motor reducer and brake. In other embodiments, the drive mechanism includes a sprocket assembly positioned on a shaft of a motor reducer and positioned to engage a series of pins connected to the curved rail. In other non-limiting embodiments, the drive mechanism may have a rack and pinion assembly driven by a motor reducer.

### BRIEF DESCRIPTION OF THE DRAWINGS

These and other features, aspects, and advantages of the present invention will become apparent from the following description and the accompanying exemplary embodiments shown in the drawings, which are briefly described below.

FIG. 1 is an elevation view of a stacker reclaimer assembly according to this disclosure.

FIG. 2A is an elevation view of a stacker reclaimer assembly in which portions of the assembly are disconnected to allow boom rotation as disclosed herein.

FIG. 2B is an elevation view of a stacker reclaimer assembly in which portions of the assembly are separated but electrically connected to allow boom rotation as disclosed herein.

FIG. 3A is a plan view of the stacker reclaimer assembly of FIG. 1 in use in a stockyard as described herein for stacking material.

FIG. 3B is a plan view of the stacker reclaimer assembly of FIG. 1 in use in a stockyard as described herein for reclaiming.

FIG. 4A is an elevation view of a stacker reclaimer assembly according to this disclosure in use to stack stockpiles of materials as described herein.

FIG. 4B is an elevation view of a stacker reclaimer assembly according to this disclosure in use to reclaim stockpiles of materials at numerous bench levels as described herein.

FIG. 5 is an elevation view of a stacker reclaimer assembly with a pivoting elevating conveyor making room for boom rotation according to this disclosure.

FIG. 6A is a plan view of the stacker reclaimer assembly of FIG. 2A or 2B with disconnected or separated components in use in a stockyard as described herein.

FIG. 6B is a plan view of the stacker reclaimer assembly of FIG. 5 with an extended range of rotation motion in use in a stockyard as described herein.

FIG. 7A is a plan view of a stacker reclaimer with an extended range of rotation motion.

FIG. 7B is a plan view of a stacker reclaimer with an extended range of rotation motion.

FIG. 8A is a plan view of a wire rope winch and sheaves allowing for the elevating conveyor of FIG. 5 to pivot along a curved rail to three operating positions as disclosed herein.

FIG. 8B is an elevation view of a wire rope winch and sheaves allowing for the elevating conveyor of FIG. 5 to pivot along a curved rail as disclosed herein.

FIG. 8C is a series of views of an alternative embodiment of the curved rail used in FIG. 8A.

FIG. 8D illustrates embodiments in which the wire rope winch has been replaced with multiple options for mechanical assemblies therein, such as a rack and pinion assembly.

FIG. 9A is an elevation view of a curved rail and travel wheels allowing for the elevating conveyor of FIG. 5 to pivot as disclosed herein.

FIG. 9B is an elevation view of a curved rail and travel wheels allowing for the elevating conveyor of FIG. 5 to pivot as disclosed herein.

FIG. 10 is a schematic illustration of a computer system used to control boom rotation and pivoting operations of an elevating conveyor as set forth herein.

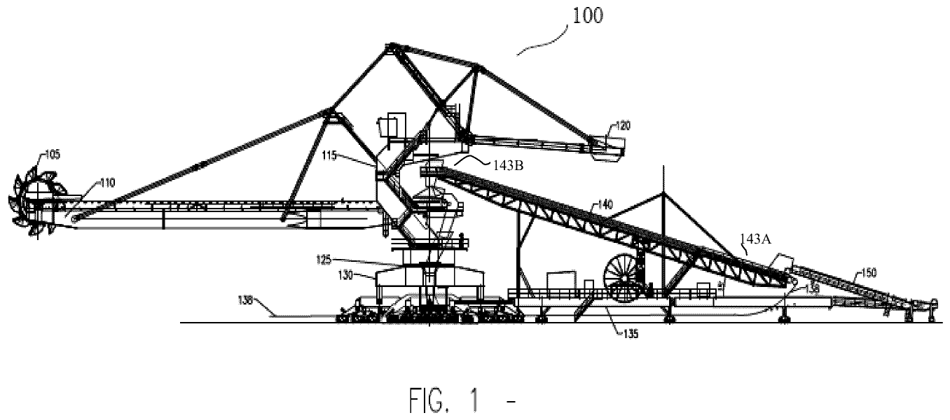

### DETAILED DESCRIPTION

The figures illustrate the exemplary embodiments in detail. However, it should be understood that the application is not limited to the details or methodology set forth in the description or illustrated in the figures. It should also be understood that the terminology is for the purpose of description only and should not be regarded as limiting.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature.

A stacker reclaimer 400 with the components of this disclosure is shown schematically in FIG. 5. The stacker reclaimer 400 may include three main sections: a rotate structure 415 (including the boom 410), a gantry 430 connected to the rotating structure 415 by a rotating slew bearing 425, and a trailing structure 435 usually connected to the gantry 430.

The rotating structure 415 sits on a rotating bearing 425 on top of the gantry 430. The gantry 430 supports the rotating structure 415 and has the travel drives 436 that allow the machine to move on the yard rails 437. The gantry 430 also tows the trailing platform 435. The trailing platform 435 supports an elevating conveyor 440 which carries material from the yard conveyor 438 up to the boom 410 located on the rotating structure 415.

The trailing platform 435 is supported by its own wheels which also ride on the yard rails 437. The angle of inclination for the elevating conveyor 440 is typically limited to about 15° to ensure material can be conveyed up the incline without rolling backwards.

The boom 410 is attached to the rotate structure 415 and has a long boom section with a radius in some non-limiting embodiments of about 200 feet. A reversible conveyor 409 is mounted on this section. For stacking, the conveyor moves material from the center of the machine discharging into a pile at the distal end of the boom on either side of the tracks. For reclaiming material, a bucket wheel 405 is mounted at the end of the boom. In non-limiting embodiments, the bucket wheel 405 is roughly 30 feet in diameter and digs material from the stockpile and loads it onto the boom conveyor which then carries the material to the center of the machine where it is transferred to the yard conveyor 438. The rotate structure 415 also has a cantilevered counterweight structure 420 diametrically opposite of the conveyor section. This structure provides balance for the rotate structure 415.

The rotate structure 415 is capable of rotating about the bearing 425 mounted on the gantry section 430. For reference, zero degrees is the point where the boom 410 is parallel with the yard rails and pointed away from the trailing structure 435. The boom can rotate nearly to 110° on each side of the yard conveyor. At about 110°, the rotate structure 415 will interfere with the structure of the elevating conveyor 440 and trailing platform 435 limiting its range. See FIG. 5.

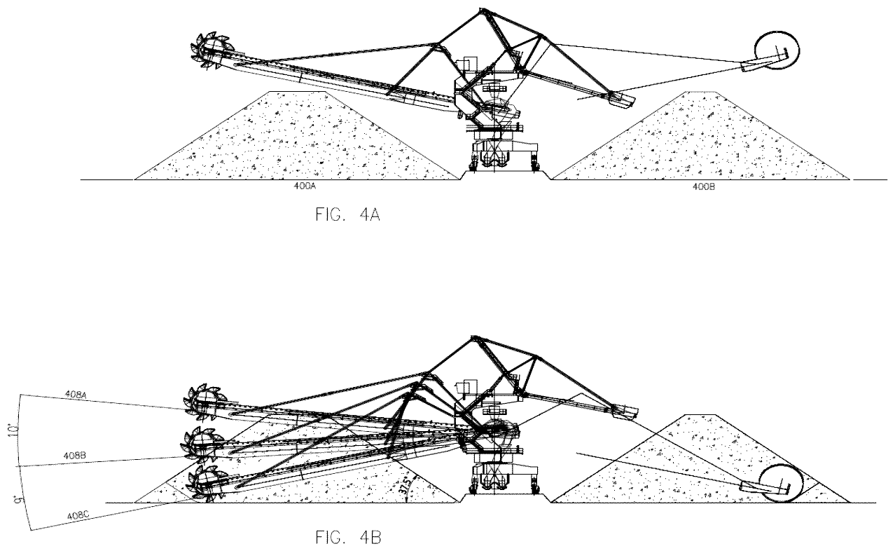

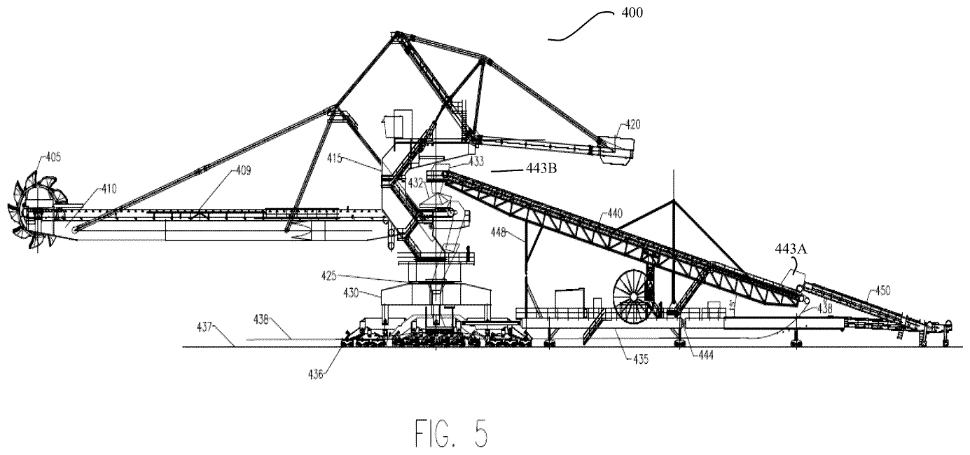

The stacker reclaimer 400 has three main motions for operation including traveling along the yard rails 437 on travel wheels 436, rotating (i.e., slewing) about the slew bearing 425, and raising or lowering (i.e., luffing) the boom 410 and its attached equipment such as the bucket wheel 405. The stacker reclaimer 400 stacks material in different shaped piles 400A, 400B as shown in FIG. 4A using all three of these motions. The final pile resulting with the boom 410 in the fully raised position shown in FIG. 4A, that in some non-limiting embodiments is equal to or approximately twelve degrees (12°) above horizontal.

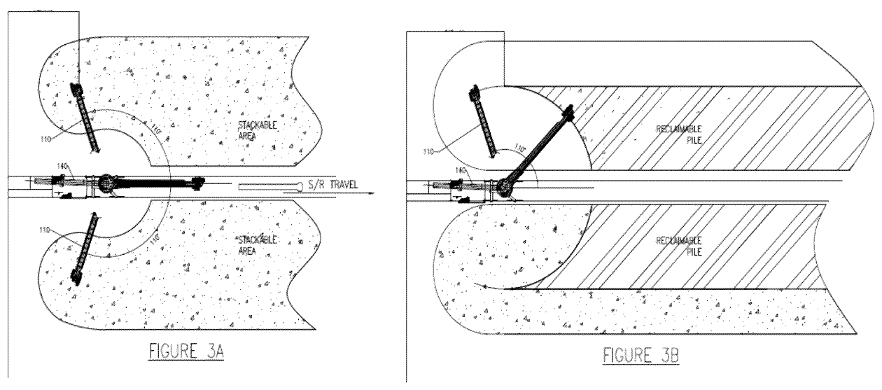

Reclaiming is accomplished by lowering the boom 410 to several different levels called benches 408A-408C. At each bench, the boom 410 is rotated through the pile 400A, 400B (slewing) with the bucket wheel 405 running to dig the material onto the boom conveyor 409. The range of slew motion is from approximately 15° to 90° on either side of the yard belt. When the end of the slewing range is reached, the stacker reclaimer 400 is moved forward to make another slewing pass on that bench. In order to reclaim a fully stacked pile in the forward direction, the stacker reclaimer 400 would need to start stacking approximately 90 feet from the rear travel stops to allow room to move the machine back to the return stops and lower the boom to reach the bottom of the stacked pile. This leaves a significant portion of yard area that is unusable, see FIGS. 3A and 3B.

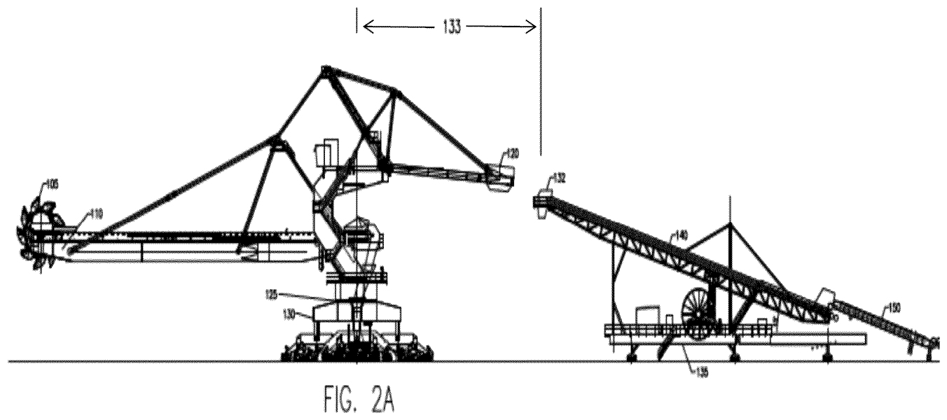

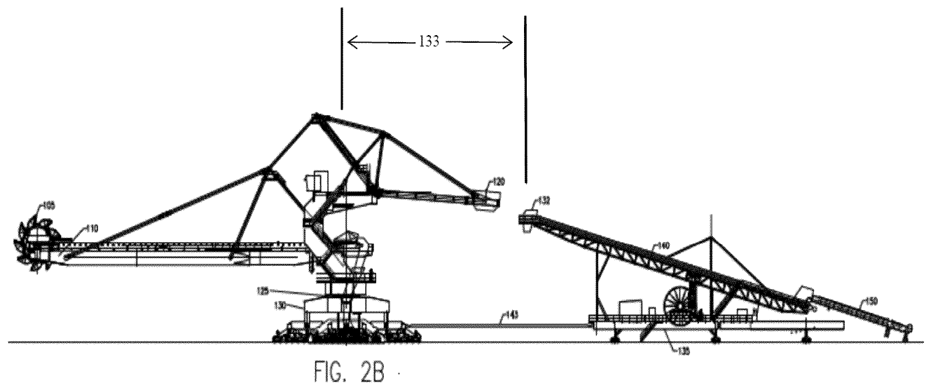

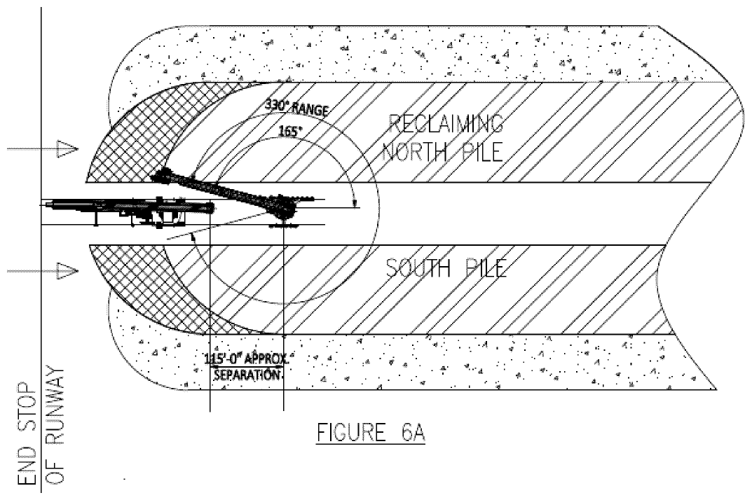

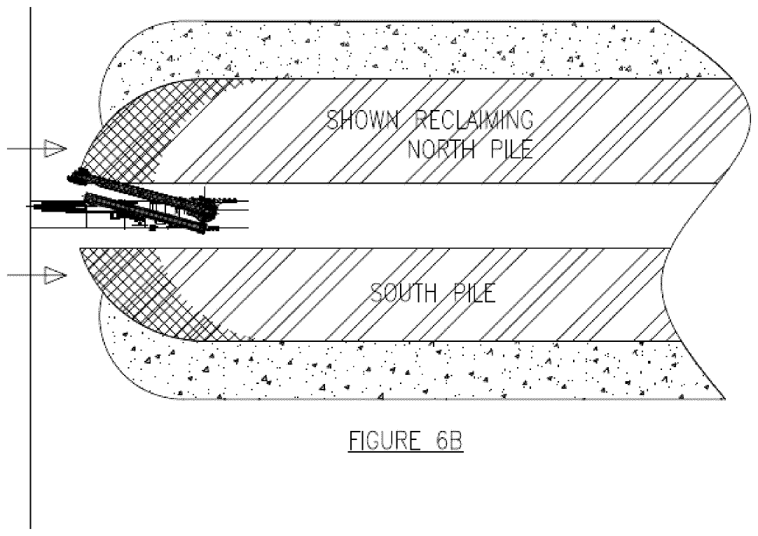

Reclaiming can also be accomplished in a similar fashion using a range of slew motion from approximately 90° to 165° on either side of the yard belt and travelling in the reverse direction. FIG. 6A shows this method of reclaiming using a disconnected or separated trailing structure as shown in FIGS. 2A and 2B. The separation still leaves a significant portion of yard area unusable.

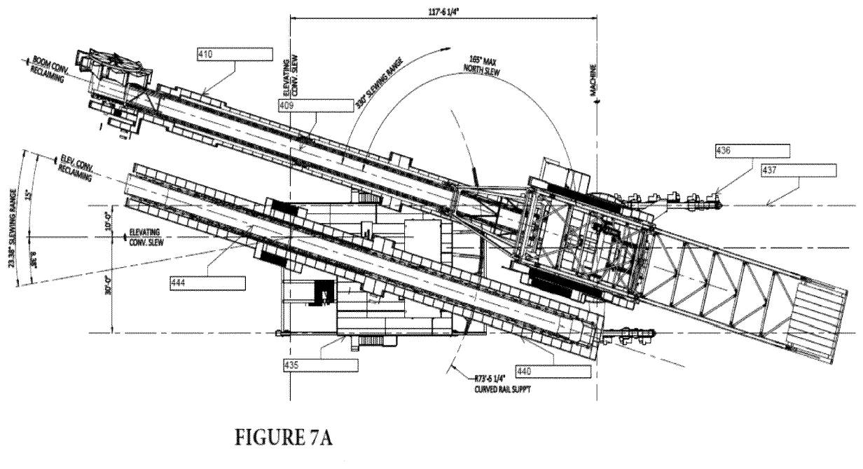

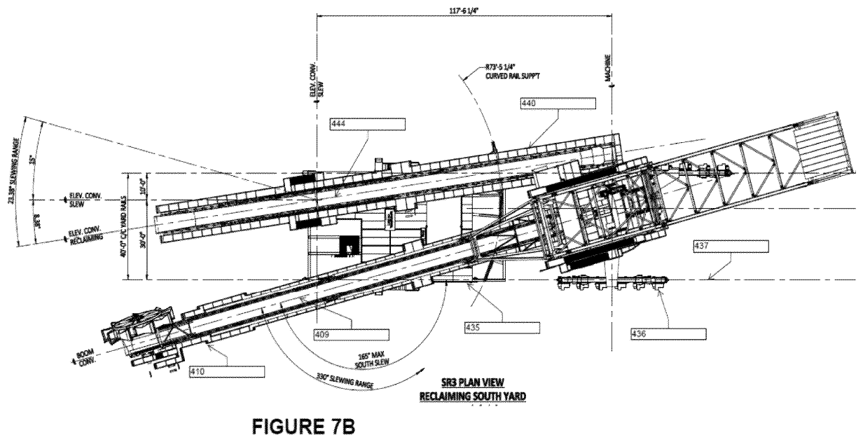

One non-limiting embodiment of this disclosure is configured to allow the elevating conveyor 440 on the trailing platform 435 to rotate (slew) about 15° left or right from its normal position. The point of rotation would be a rotational bearing located towards the end of the trailing platform 435 opposite of the gantry 430. This will allow the elevating conveyor 440 to move from the normal centerline by 10 to 15 feet eliminating the interference with the boom structure when it is slewed to 170°. See FIGS. 7A and 7B. The resulting additional reclaimable yard area is shown in FIG. 6B.

There are several challenges with integrating the slewing elevating conveyor 440 into a stacker reclaimer 400. As seen in FIG. 5, the elevating conveyor 440 extends beyond the trailing platform 435 in both directions. On the lower end the elevating conveyor extends to meet a tripper structure 450 that allows material from the yard conveyor 438 to feed onto the elevating conveyor 440. On the upper end, the elevating conveyor extends to a load hood 433 to help contain dust from the material feeding into the stack hopper 432. The elevating conveyor must remain aligned with the feed and discharge points for stacking operation, this is 0° of rotation. The stacking position will be locked with a pin type lock and actuator indicating to the control system that stacking operation is allowed. The pin will also lock in the left and right slew positions indicating to the control system that reclaiming operation is allowed beyond 90° slew angle for the boom 410.

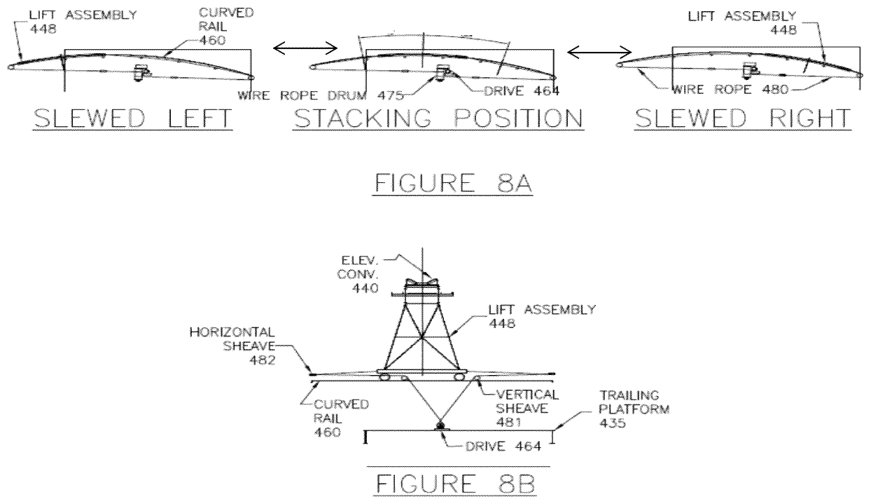

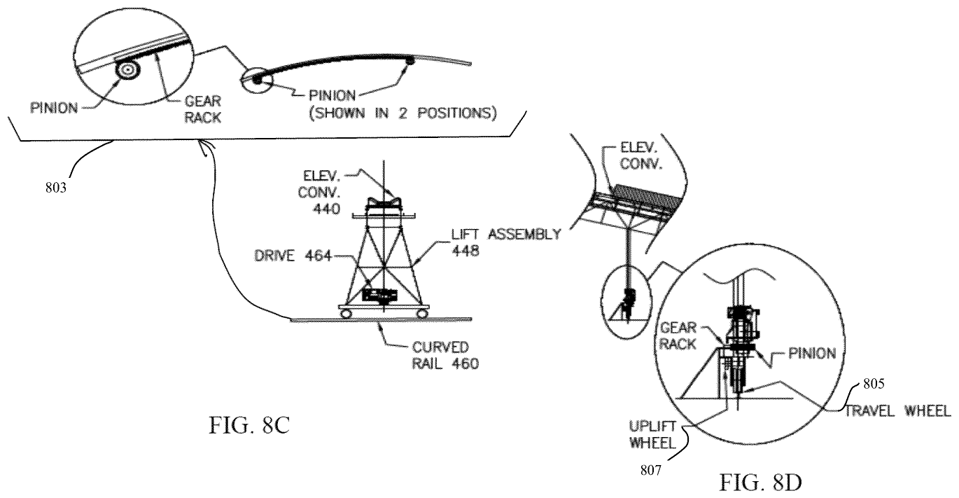

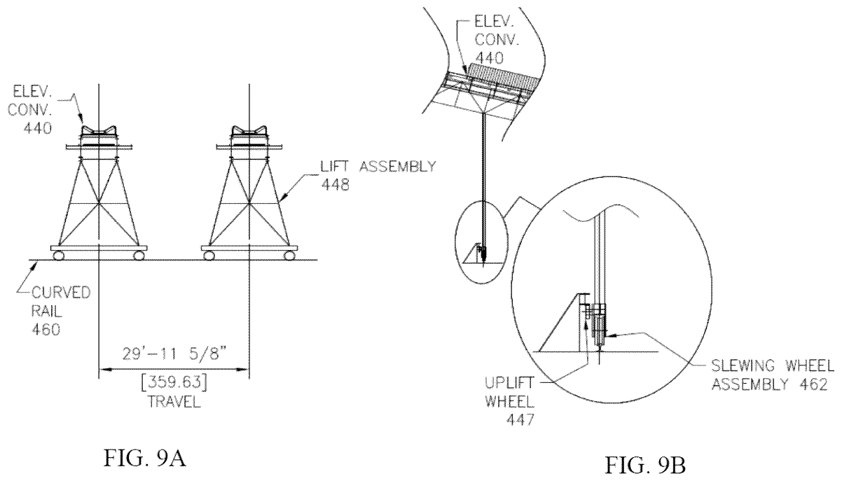

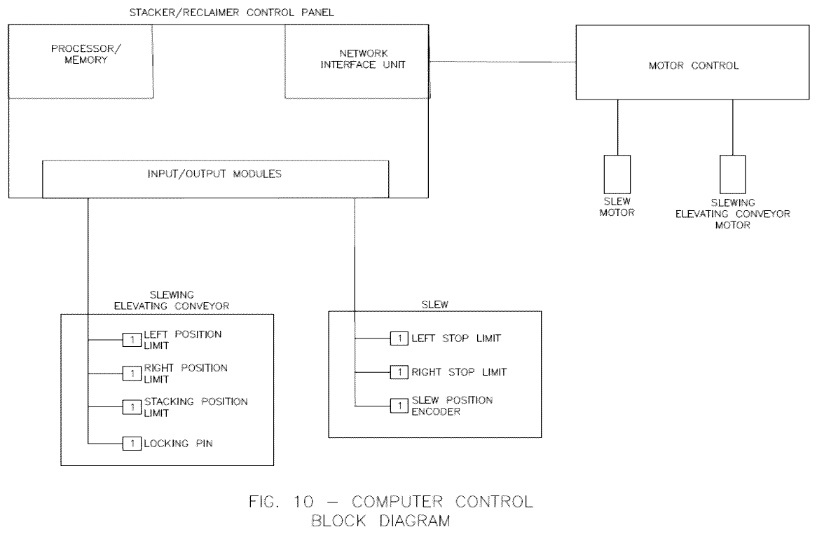

The center of rotation for the slewing operation will be about a rotational bearing 444 mounted on the trailing platform 435 which will support the slewing elevating conveyor 440. Due to the load of the elevating conveyor, an additional support, i.e., a lift assembly 448 is necessary at the opposite end of the trailing platform. This support will be in the form of a wheel assembly 462 that will ride on a curved rail 460 mounted to the trailing platform, see FIG. 9. A drive mechanism 464, mounted to the trailing structure will be used to slew the elevating conveyor. One non-limiting embodiment of this disclosure, the drive 464 will consist of a brake, motor and reducer with a wire rope drum 475 mounted on the reducer output shaft, see FIGS. 8A and 8B. The wire rope drum will payout and retrieve a wire rope 480 attached to each side of the lift assembly 448. The wire rope is routed through vertical sheaves 481 and horizontal sheaves 482 mounted at each end of the curved rail 460. The drive 464 rotates the drum 475 to retrieve one rope while simultaneously paying out the other rope to move the slewing elevating conveyor travel wheels 462 along the arc of the curved rail to the left or to the right. A limit switch will be used at the travel limit in either direction to make sure that the slewing elevating conveyor is fully positioned before the main boom 410 can be rotated beyond the 90° slew angle. FIG. 8C shows additional non-limiting embodiments of this disclosure that can be used instead of the wire rope pulling the assembly via the curved rail. Additional options include:

Chain and Sprocket Drive—A drive assembly including a motor reducer and brake would be mounted to the lift assembly. A sprocket on the output shaft of the reducer would engage a chain fixed along the curved rail structure. Idle sprockets would be used to guide the chain around the drive sprocket. This option is relatively simple and cost effective.

Sprocket and Pin Drive—A drive assembly including a motor reducer and brake would be mounted to the lift assembly. A sprocket on the output shaft of the reducer (similar to the chain sprocket) would engage a series of pins along the curved rail structure. This option is similar to the chain drive in its simplicity and is convenient to maintain.

Rack and Pinion Drive—A drive assembly including a motor reducer and brake would be mounted to the lift assembly. A pinion gear on the output shaft of the reducer would engage a curved rack gear fixed along the curved rail structure. This is a robust and reliable option.

A structure along the curved rail 460 will be used to engage an uplift wheel 447 at each of the travel wheels. The uplift wheel will prevent the slewing elevating conveyor from becoming unstable and lifting from the travel rails as it is slewed to the left or right. The loading hood 433 at the upper end of the elevating conveyor will be designed to allow clearance moving the hood over the stacking chute from the left or the right. Additional interlocks are required in the control system to make sure that the slewing elevating conveyor cannot be moved to the same side of the tracks as the rotating structure and to make sure that the boom 410 is positioned at 90° while the elevating conveyor 440 is rotated.

The final design of the slewing elevating conveyor will also include counterweight, as needed, when the elevating conveyor is rotated to the full left or right position. The conveyor will overhang the trailing platform at these locations and must remain stable during operation of the stacker reclaimer.

In one non-limiting embodiment, a trailing platform 435 for use in a stacker reclaimer 400 assembly may encompass an elevating conveyor 440 extending across the trailing platform. A rotational bearing assembly 444 connects the trailing platform to the elevating conveyor at a position that is proximate to a first end 443A of the elevating conveyor, wherein the rotational bearing provides an opposite end 443B of the elevating conveyor with a rotational range of motion relative to the trailing platform. A curved rail 460 connects to the trailing platform between the rotational bearing and the opposite end of the elevating conveyor. A travel wheel assembly 805 supports a lift assembly 448 on the curved rail 460. The lift assembly 448 extends above the curved rail 460 on the trailing platform 435 and positions the opposite end 443B of the elevating conveyor at a height relative to the first end 443A of the elevating conveyor 440. A drive mechanism imparts motion to the lift assembly and the elevating conveyor along the curved rail via the travel wheel assembly.

The drive mechanism may encompass many different mechanical constructions that allow for the lift assembly 448 to impart arcuate motion to the opposite end 443B of the elevating conveyor 440. For example, in one non-limiting embodiment shown in FIGS. 8A and 8B, a wire rope 480 may be connected to the lift assembly at each end and defining a radius of curvature corresponding to the curved rail. A winch drive mechanism 464 moves the wire rope 480 and imparts motion to the lift assembly 448 and the elevating conveyor 440 along the curved rail 460 via the travel wheel assembly 805. In other embodiments, the drive mechanism may include a chain and sprocket assembly imparting motion to the lift assembly via a motor reducer and brake. For example, and without limiting the disclosure, the drive mechanism may include a sprocket assembly positioned on a shaft of a motor reducer and positioned to engage a series of pins connected to the curved rail. In yet another embodiment, shown by example in FIGS. 8C and 8D, the drive mechanism may include a rack and pinion assembly 803 driven by a motor reducer. An uplift wheel 807 may be included and held in place by a structure, such as a lip or wall, along the curved rail to maintain the travel wheel assembly within the curved rail. FIGS. 6A, 6B, 7A, and 7B shows that the rotational range of motion of the opposite end of the elevating conveyor extends along an arc that is substantially parallel to the trailing platform.

In non-limiting embodiments, the lift assembly 448 of this disclosure defines an angle of the elevating conveyor 440 relative to the trailing platform 435 that is approximately 15°. The lift assembly fixes a height of the elevating conveyor relative to the curved rail on the trailing platform. Accordingly, numerous limit switches may be included to detect a plurality of positions of the elevating conveyor relative to the curved rail.

The above described trailing platform 435 with controlled arcuate motion at an opposite end 443B may be part of an overall stacker reclaimer (“S/R”) system 400 that includes a rotate structure 415 connected to a boom 410 comprising a boom conveyor 409 for moving reclaimable material to and from stored piles. A gantry structure 430 may include a rotatable slew bearing 425 connecting the rotate structure 415 to the gantry 430, wherein the rotatable slew bearing provides a separate arcuate range of motion (different from the range of motion of the opposite end of the trailing platform) to the boom and the boom conveyor. In some embodiments, the trailing platform may be connected to the gantry temporarily, and the trailing platform typically includes an elevating conveyor extending across the trailing platform. A rotational bearing 444 connects the trailing platform to the elevating conveyor at a position that is proximate to a first end 443A of the elevating conveyor, wherein the rotational bearing provides an opposite end 443B of the elevating conveyor with a rotational range of motion relative to the trailing platform. A curved rail 460 mounted to the trailing platform on an elevated structure is positioned between the rotational bearing 444 and the opposite end 443B of the elevating conveyor. A lift assembly extends above the curved rail on the trailing platform and positions the opposite end of the elevating conveyor at a height relative to the first end of the elevating conveyor. A drive mechanism imparting motion to the lift assembly and the elevating conveyor along the curved rail via the travel wheel assembly.

The drive mechanism may encompass many different mechanical constructions that allow for the lifting assembly to impart arcuate motion to the opposite end of the elevating conveyor. For example, in one non-limiting embodiment shown in FIGS. 8A and 8B, a wire rope 480 may be connected to the lift assembly at each end and defining a radius of curvature corresponding to the curved rail. A winch drive mechanism moves the wire rope and imparts motion to the lift assembly and the elevating conveyor along the curved rail via the travel wheel assembly. In other embodiments, the drive mechanism may include a chain and sprocket assembly imparting motion to the lift assembly via a motor reducer and brake. For example, and without limiting the disclosure, the drive mechanism may include a sprocket assembly positioned on a shaft of a motor reducer and positioned to engage a series of pins connected to the curved rail. In yet another embodiment, shown by example in FIGS. 8C and 8D, the drive mechanism may include a rack and pinion assembly driven by a motor reducer. An uplift wheel may be included and held in place by a structure, such as a lip or wall, along the curved rail to maintain the travel wheel assembly within the curved rail. FIGS. 6A, 6B, 7A, and 7B shows that the rotational range of motion of the opposite end of the elevating conveyor extends along an arc that is substantially parallel to the trailing platform. This rotation provides clearance that is sufficient for the rotate structure to move the boom without interference from the elevating conveyor.

In non-limiting embodiments, the rotational range of motion of the elevating conveyor is from 0° to 15° in either direction relative to a center line extending in a longitudinal direction through a center of the trailing platform and bisecting the rotational range of motion of the elevating conveyor. In other embodiments, the arcuate range of motion of the boom is from 0° to 170° in either direction relative to a center line extending in a longitudinal direction through center of the trailing platform and bisecting the arcuate range of motion of the boom.

In operation, and without limiting this disclosure, FIGS. 6A, 6B, 7A, 7B show that arcuate motion of the boom is opposite rotational motion of the elevating conveyor. A system including the above described components and operations may utilize a computer environment described below and in FIG. 10, wherein interlock switches prevent the elevating conveyor from rotating toward the same side of the trailing platform as the boom.

The figures of this disclosure also include a loading hood connected to the opposite end of the elevating conveyor in a position that defines additional clearance between the loading hood and the rotate structure.

The present disclosure has been described with reference to example embodiments, however, persons skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, drive methods, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability.

Accordingly, all such modifications are intended to be included within the scope of the present disclosure. Other substitutions, modifications, changes and omissions may be made in the design, operating conditions and arrangement of the preferred and other exemplary embodiments without departing from the spirit of the present subject matter.

In example implementations, at least some portions of the activities may be implemented in software provisioned on a networking device. In some embodiments, one or more of these features may be implemented in computer hardware, provided external to these elements, or consolidated in any appropriate manner to achieve the intended functionality. The various network elements may include software (or reciprocating software) that can coordinate image development across domains such as time, amplitude, depths, and various classification measures that detect movement across frames of image data and further detect particular objects in the field of view in order to achieve the operations as outlined herein. In still other embodiments, these elements may include any suitable algorithms, hardware, software, components, modules, interfaces, or objects that facilitate the operations thereof.

Furthermore, computer systems described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the Figures may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory) can store data used for the operations described herein. This includes the memory being able to store instructions (e.g., software, logic, code, etc.) in non-transitory media, such that the instructions are executed to carry out the activities described in this Specification. A processor can execute any type of computer readable instructions associated with the data to achieve the operations detailed herein in this Specification. In one example, processors (e.g., processor) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’

1. A trailing platform for use in a stacker reclaimer assembly, comprising: an elevating conveyor extending across the trailing platform;
a rotational bearing assembly connecting the trailing platform to the elevating conveyor at a position that is proximate to a first end of the elevating conveyor, wherein the rotational bearing provides an opposite end of the elevating conveyor with a rotational range of motion relative to the trailing platform;
a curved rail connected to the trailing platform between the rotational bearing and the opposite end of the elevating conveyor;
a travel wheel assembly supporting the lift assembly on the curved rail;
a lift assembly extending above the curved rail on the trailing platform and positioning the opposite end of the elevating conveyor at a height relative to the first end of the elevating conveyor;
a drive mechanism imparting motion to the lift assembly and the elevating conveyor along the curved rail via the travel wheel assembly.

2. The trailing platform of claim 1, wherein the drive mechanism comprises:
a wire rope connected to the lift assembly at each end and defining a radius of curvature corresponding to the curved rail; and
a winch drive mechanism moving the wire rope and imparting motion to the lift assembly and the elevating conveyor along the curved rail via the travel wheel assembly.

3. The trailing platform of claim 1, wherein the drive mechanism comprises a chain and sprocket assembly imparting motion to the lift assembly via a motor reducer and brake.

4. The trailing platform of claim 1, wherein the drive mechanism comprises a sprocket assembly positioned on a shaft of a motor reducer and positioned to engage a series of pins connected to the curved rail.

5. The trailing platform of claim 1, wherein the drive mechanism comprises a rack and pinion assembly driven by a motor reducer.

6. The lift assembly of claim 1, further comprising an uplift wheel connected to a structure along the curved rail to maintain the travel wheel assembly within the curved rail.

7. The trailing platform of claim 1, wherein the rotational range of motion of the opposite end of the elevating conveyor extends along an are that is substantially parallel to the trailing platform.

8. The trailing platform of claim 1, wherein the lifting assembly defines an angle of the elevating conveyor relative to the trailing platform that is approximately 15°.

9. The trailing platform of claim 1, wherein the lifting assembly fixes a height of the elevating conveyor relative to the curved rail on the trailing platform.

10. The trailing platform of claim 1, further comprising limit switches detecting a plurality of positions of the elevating conveyor relative to the curved rail.

11. A stacker reclaimer system comprising:
a rotate structure connected to a boom comprising a boom conveyor for moving reclaimable material to and from stored piles;
a gantry structure comprising a rotatable slew bearing connecting the rotate structure to the gantry, wherein the rotatable slew bearing provides an arcuate range of motion to the boom and the boom conveyor;
a trailing platform connected to the gantry, the trailing platform comprising:
an elevating conveyor extending across the trailing platform;
a rotational bearing assembly connecting the trailing platform to the elevating conveyor at a position that is proximate to a first end of the elevating conveyor, wherein the rotational bearing provides an opposite end of the elevating conveyor with a rotational range of motion relative to the trailing platform;
a curved rail mounted to the trailing platform on an elevated structure between the rotational bearing and the opposite end of the elevating conveyor;
a lift assembly extending above the curved rail on the trailing platform and positioning the opposite end of the elevating conveyor at a height relative to the first end of the elevating conveyor;
a drive mechanism imparting motion to the lift assembly and the elevating conveyor along the curved rail via the travel wheel assembly.

12. The stacker reclaimer system of claim 11, wherein the drive mechanism comprises:
a wire rope connected to the lift assembly at each end and defining a radius of curvature corresponding to the curved rail; and
a winch drive mechanism moving the wire rope and imparting motion to the lift assembly and the elevating conveyor along the curved rail via the travel wheel assembly.

13. The stacker reclaimer system of claim 12, wherein the drive mechanism comprises a chain and sprocket assembly imparting motion to the lift assembly via a motor reducer and brake.

14. The stacker reclaimer system of claim 12, wherein the drive mechanism comprises a sprocket assembly positioned on a shaft of a motor reducer and positioned to engage a series of pins connected to the curved rail.

15. The stacker reclaimer system of claim 12, wherein the drive mechanism comprises a rack and pinion assembly driven by a motor reducer.

16. The stacker reclaimer system of claim 11, wherein the clearance is sufficient for the rotate structure to move the boom without interference from the elevating conveyor.

17. The stacker reclaimer system of claim 11, wherein the rotational range of motion of the elevating conveyor is from 0° to 15° in either direction relative to a center line extending in a longitudinal direction through a center of the trailing platform and bisecting the rotational range of motion of the elevating conveyor.

18. The stacker reclaimer system of claim 11, wherein the arcuate range of motion of the boom is from 0° to 170° in either direction relative to a center line extending in a longitudinal direction through center of the trailing platform and bisecting the arcuate range of motion of the boom.

19. The stacker reclaimer system of claim 11, wherein arcuate motion of the boom is opposite rotational motion of the elevating conveyor.

20. The stacker reclaimer system of claim 11, further comprising interlock switches preventing the elevating conveyor from rotating toward the same side of the trailing platform as the boom.

21. The stacker reclaimer system of claim 11, further comprising a loading hood connected to the opposite end of the elevating conveyor in a position that defines additional clearance between the loading hood and the rotate structure.

22. The stacker reclaimer system of claim 11, further comprising a computer comprising a processor and computer memory storing software to control the rotational motion of the elevating conveyor and the arcuate motion of the boom.
